(19) United States
(12) Patent Application Publication
(10) Pub. No.: US 2013/0006580 A1
(43) Pub. Date: Jan. 3, 2013

(54) GENERATING AN INDICATION OF A PROBABILITY OF A HYPOTHESIS BEING CORRECT BASED ON A SET OF OBSERVATIONS

(75) Inventors: David Nicholson, Thornbury (GB); Christopher Mark Lloyd, Cotham (GB); Mark Lawrence Williams, Bristol (GB)

(73) Assignee: BAE SYSTEMS plc, London (GB)

(21) Appl. No.: 13/636,635

(22) PCT Filed: Mar. 4, 2011
(86) PCT No.: PCT/GB2011/050434

§ 371 Date: Sep. 21, 2012

(30) Foreign Application Priority Data
Mar. 22, 2010 (GB) 1004688.6

(51) Int. Cl. G06F 17/18

(52) U.S. Cl. 702/181

(57) ABSTRACT

A method of generating an indication of a probability of a hypothesis being correct based on a set of observations includes obtaining data representing first and second sets of observations. Data representing a set of hypotheses at least partially derivable from the first and the second set of observations can also be obtained. Plural data associations can be generated between at least some data in the first and second sets to indicate a probability of at least some of the generated data associations being correct. The data representing the set of hypotheses and the indication of the probability of at least some of the generated data associations being correct can be used to generate an indication of a probability of at least one of the hypotheses represented by the data being correct.

### BACKGROUND TO THE INVENTION

The present invention relates to generating an indication of a probability of a hypothesis being correct based on a set of observations.

Various types of devices for monitoring different types of events/information are available, such as cameras, radars, listening devices, computers configured to examine communications, and so on. In some cases the information (generally referred to herein as “observations”) obtained/provided by such devices is used to assist in determining the probability of one or more hypothesis being true. The term “hypothesis” is intended to be interpreted broadly. For instance, a hypothesis can comprise a postulation that the reason why a particular set of components have been delivered to a production plant is because they are going to be used to assemble a particular type of product, but can apply to any problem where weak data from multiple sources has to be correlated and analysed to draw inferences about multiple hypotheses.

Dealing with data relating to observations taken from several sources and using it to get an indication of the likelihood of a hypothesis being correct can be difficult and complex for humans and it is desirable to use computing devices to assist with the task. This can involve creating a model based around the observations and their implications with respect to the hypotheses and using it to try to determine the probability of at least one of those hypotheses being correct. However, this can be a difficult process because of the uncertainties inherent in many hypotheses based around observations, e.g. a particular component could be used in more than one type of product; a component could be used for a different product that is not contemplated by any hypothesis, or may be intended for long-term storage, etc.

Embodiments of the present invention are intended to address at least some of the problems outlined above.

### SUMMARY OF THE INVENTION

According to one aspect of the present invention there is provided a (computer-implemented) method of generating an indication of a probability of a hypothesis being correct based on (electronic data representing) a set of observations, the method including:

obtaining data representing a first set of observations;

obtaining data representing a second set of observations;

obtaining data representing a set of hypotheses at least partially derivable from the first and the second set of observations;

generating a plurality of data associations between at least some data in the first set and data in the second set;

generating an indication of a probability of at least some of the generated data associations being correct, and

using the data representing the set of hypotheses and the indication of the probability of at least some of the generated data associations being correct to generate an indication of a probability of at least one of the hypotheses represented by the data being correct.

The step of generating the plurality of data associations between at least some data in the first set and data in the second set can include generating a data association matrix. An ij^{th} element of the data association matrix may comprise a value representing a joint probability that data relating to an i^{th} observation from the first set is associated with data relating to a j^{th} observation from the second set.

The step of generating the indication of a probability of at least some of the generated data associations being correct can involve a Softassign technique. Alternatively, the step may involve an Information-form data association, Markov-Chain Monte-Carlo EM or Fourier-theoretic inference on permutations technique.

The set of hypotheses may comprise a hypothesis that a set of products is being assembled at a set of locations, and the first and second observations sets may comprise observations relating to components potentially used in the assembly of the products. For example, the observations may comprise an observation of a said component being transported to one of the locations. The observation may be time-stamped. The step of using the data representing the set of hypotheses and the indication of the probability of at least some of the generated data associations being correct may include computing combinations of particular said components being used to assemble a particular said product at a particular said location. Output relating to the computed correctness may be used in detecting a threat.

The step of using the data representing the set of hypotheses and the indication of the probability of at least some of the generated data associations being correct may involve a hyper-geometric distribution (HGM) technique. The hyper-geometric distribution (HGM) technique can involve finding a best hyper-geometric distribution.

According to yet another aspect of the present invention there is provided a computer program product comprising computer readable medium, having thereon computer program code means, when the program code is loaded, to make the computer execute a method substantially as described herein.

According to another aspect of the present invention there is provided a system configured to generate an indication of a probability of a hypothesis being correct based on a set of observations, the system including:

a device configured to obtain data representing a first set of observations;

a device configured to obtain data representing a second set of observations;

a device configured to obtain data representing a set of hypotheses at least partially derivable from the first and the second set of observations;

a device configured to generate a plurality of data associations between at least some data in the first set and data in the second set;

a device configured to generate an indication of a probability of at least some of the generated data associations being correct, and

a device configured to use the data representing the set of hypotheses and the indication of the probability of at least some of the generated data associations being correct to generate an indication of a probability of at least one of the hypotheses represented by the data being correct.

Whilst the invention has been described above, it extends to any inventive combination of features set out above or in the following description. Although illustrative embodiments of the invention are described in detail herein with reference to the accompanying drawings, it is to be understood that the invention is not limited to these precise embodiments. As such, many modifications and variations will be apparent to practitioners skilled in the art. Furthermore, it is contemplated that a particular feature described either individually or as part of an embodiment can be combined with other individually described features, or parts of other embodiments, even if the other features and embodiments make no mention of the particular feature. Thus, the invention extends to such specific combinations not already described.

### BRIEF DESCRIPTION OF THE DRAWINGS

The invention may be performed in various ways, and, by way of example only, embodiments thereof will now be described, reference being made to the accompanying drawings in which:

FIG. 1 is a schematic illustration of an example scenario having a set of associated hypotheses;

FIG. 2 is a high-level flowchart illustrating how probabilities relating to the hypotheses can be computed and processed;

FIGS. 3, 4 and 5 are graphs relating to analysis of example outputs of the process, and

FIG. 6 is a flowchart illustrating example methods of generating an indication of a probability of a hypothesis being correct based on a set of observations.

### DESCRIPTION OF PREFERRED EMBODIMENT

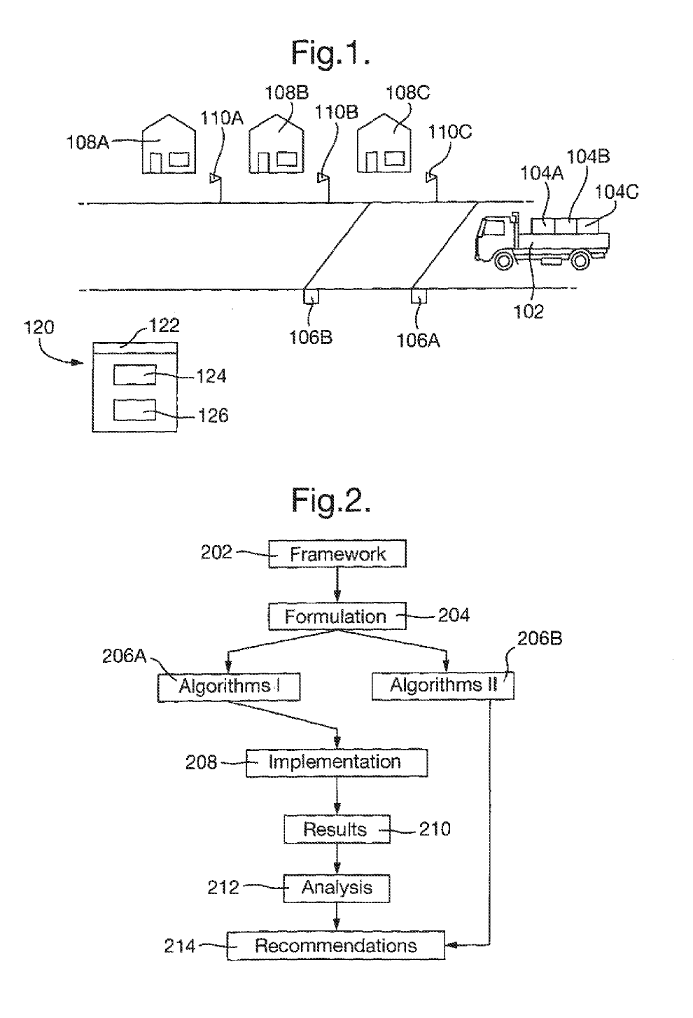

FIG. 1 illustrates a scenario including a delivery vehicle 102 carrying a set of components 104A-104C along a road. The road is fitted with CCTV cameras/sensors 106A, 106B. Three factories 108A-108C are also shown in the diagram, with the approach to each factory being monitored by respective cameras 110A-110C. In this scenario, the intention is to estimate what products are being built by the factories, based on observations of which components were delivered to them. In order to do this, it is necessary to know which components are entering the factories. The factory cameras 110 only observe delivery vehicle types, which is considered very weak information because most types of components can be carried by most vehicles. However, components being carried by the vehicles are observed directly by the road cameras 106. This motivates a two-step formulation of the problem to be solved:
1. Use the time-stamped delivery vehicle observations to generate candidate road-to-factory associations.
2. For each association, use implied component information to determine production at each factory.

It will be appreciated that the scenario presented is simplified, but serves as a sufficient example of how observations can be used to obtain an indication of the probability of a hypothesis being correct. For other scenarios, different numbers and types of sensing devices can be used to record different types of information, which may be completely unrelated to vehicles delivering components to factories for in use in assembling products.

The scenario outline above can be associated with a potential threat. In general, a threat can be considered to comprise a signal of perceived intent to cause harm in some way. For example, it could be a medical threat (to cause disease), an environmental threat (to cause flooding), or a military threat (to cause damage to a high value asset). The adversary, or source of the threat, could be natural (e.g. a virus, the weather), man-made (e.g. a missile or improvised explosive device), or human (e.g. a computer hacker). Threat signals are typically difficult to detect because they are weakly embedded in a background of clutter and noise from partial sensor observations. In addition, models of the signal and the background may be unavailable. Thus, a general problem in the field of threat detection is extracting a weak signal of hostile intent from its background under challenging conditions of data and model uncertainty.

Some embodiments of the present invention may be concerned with the detection of a non-conventional military threat. Such threats are posed by rogue nations or insurgent groups, and include chemical, biological, radiological, and nuclear (CBRN) weapons, devices and delivery systems. These threats can unfold over a period of weeks or months and any data is likely to be sparse and highly uncertain. During this period the adversary is envisaged to acquire the materiel and parts that are necessary to manufacture the threat. Each acquisition event can be referred to as a “transaction”. However, an intelligent adversary will also attempt to conceal its threatening activity by arranging covert deliveries and manufacture a range of non-threatening items. Thus, a specific threat problem in this context is to infer whether the adversary is manufacturing a CBRN threat by observing its transactions and exploiting domain knowledge where available.

FIG. 1 also shows a computing device 120 that includes a communications interface 122. Data from the sensing devices 106 and cameras 108 is transferred, directly or indirectly, to the computer via the interface, e.g. by means of wireless signals. The computer further includes a processor 124 and a memory 126 and is configured to use the observational data to generate probabilities related to the hypotheses under consideration. Again, it will appreciated that the diagram is simplified and many variations are possible, e.g. the probability computations could be distributed over several computing devices, additional devices may store and process the observational data before it is transmitted to the computer, etc.

FIG. 2 gives an overview of an approach to solving a problem involving a scenario such as that of FIG. 1, which involves determining the probabilities of a set of hypotheses being correct. At step 202, a representation of the problem is created. At step 204, the formal representation of the problem is refined as the problem variables are manipulated. Step 206A represents an accurate inference procedure being formulated based on the problem variables. This procedure can be a brute-force type technique that guarantees accurate results, but is computationally expensive. Step 206B represents formulation of an inference procedure that is less computationally expensive and provides less accurate results that are considered acceptable approximations. It will be appreciated that the flowchart illustrates an experimental process and in other embodiments, only one of the steps 206A, 206B may be implemented; for instance, in a practical implementation, only the less computationally-expensive process 206B may be executed.

At step 208 inference procedures are implemented and executed on a computing device. At step 210 results based on the computations of step 208 are output, e.g. displayed to a user and/or stored for further processing. Steps 212 and 214 represent optional procedures based on analysing the results and making recommendations based on that analysis, e.g. take certain actions if a factory is found to be producing a certain type of product.

Embodiments of the invention address the problem using Probability Theory, in particular Bayes' Rule. The person skilled in the art will be familiar with expressing the problem using the notation below:

$$p ( x \vert Z ) = \frac{p ( Z \vert x ) p ( x )}{\int p ( Z \vert x ) p ( x ) d x}$$

where x is the state space and Z is the data.
For the problem under consideration:

x≡(x₁^{p}, x₂^{p}, . . . , x₁₀^{p}, x^{v}, x^{t})

where x^{p}₁ . . . x^{p}₁₀ represent the state space over product manufacture, x^{v} represents state space over delivery vehicles, and x^{t} represents state space over delivery times.

As mentioned previously, Z represents the data derived from the observations:

Z≡Z₁^{p}∪ . . . ∪Z₁₀^{p}∪Zᵥ^{r}∪Zᵥ^{f}∪Zₜ^{r}∪Zₜ^{f}

where Z^{p}₁ . . . Z^{p}₁₀ represents observations of components (partition unknown); Z^{r}ᵥ, Z^{f}ᵥ, represent observation of delivery vehicles and Z^{r}ₜ, Z^{f}ₜ represent observations of delivery times.

The following set of assumptions are made regarding the scenario:

Product production at each factory is independent and is also independent of delivery vehicle and delivery time

p(x)=p(x₁^{p})·p(x₂^{p})· . . . ·p(x₁₀^{p})·p(x^{v})·p(x^{t})

Observed component depends only on true component

p(Zᵢ^{p}|xᵢ^{p})=p(Zᵢ^{p}|x)

Observed delivery vehicle depends only on true delivery vehicle

p(Zᵥ^{r}|x^{v})=p(Zᵥ^{r}|x), p(Zᵥ^{f}|x^{v})=p(Zᵥ^{f}|x)

Delivery time observation depends only on true delivery time

p(Zₜ^{r}|x^{t})=p(Zₜ^{r}|x), p(Zₜ^{f}|x^{t})=p(Zₜ^{f}|x)

The method can involve associating the observational data. A determination of the partitioning of component observations among factories needs to be made and Zⁱₚ can be determined once a road-to-factory association has been made. An association based on the likelihood that a delivery vehicle observed on the road is the same delivery vehicle seen at a factory can be made using vehicle and time information only. A data association matrix is populated, as set out below, with the joint probability of each data under the assumption the association is true:

$$\begin{matrix}\begin{matrix} & & \\ p ( {}_{i}^{ }{z}{}_{ }^{f} , {}_{j}^{ }{z}{}_{ }^{r} \vert a ) & & \\ & & \\ & & \end{matrix} & \begin{matrix} & & \\ p ( {}_{i}^{ }{z}{}_{ }^{f} , {\overline{z}}^{r} \vert a ) & & \\ & & \\ & & \end{matrix} \\ \begin{matrix} & & \\ p ( {}_{}^{ }{\overline{z}}{}_{ }^{f} , {}_{j}^{ }{z}{}_{ }^{r} \vert a ) & & \\ & & \\ & & \end{matrix} & \begin{matrix}\begin{matrix} & & \\ 1 & & \end{matrix} \\ \end{matrix}\end{matrix} \begin{matrix}p ( z \vert {Z}^{r} , {Z}^{r} ) ∝ {\prod }_{i , j ∈ a}^{ } p ( {}_{i}^{ }{z}{}_{ }^{f} , {}_{j}^{ }{z}{}_{ }^{r} \vert a ) . \\ {\prod }_{i ∈ a}^{ } p ( {}_{i}^{ }{z}{}_{ }^{f} , {\overline{z}}^{r} \vert a ) \cdot {\prod }_{j ∈ a}^{ } p ( {\overline{z}}^{f} , {}_{j}^{ }{z}{}_{ }^{r} \vert a )\end{matrix}$$

The skilled person will be able to implement a version where more than two sets of observations are provided, e.g. by using multiple matrices. Again, certain assumptions are made:
The likelihood of associating i→j is product of time and vehicle association likelihoods
Assume there is no observation uncertainty of time information
Assume the delay between road and factory observations follows gamma distribution with “adaptive threshold” (see L. D. Stone, T. M. Tran, and M. L. Williams, Improvement in track-to-track association from using an adaptive threshold, Proceedings of the 12^{th} International Conference in Information Fusion (Fusion 09), Seattle Wash., July 2009)
Estimate k, θ from data
Assume delay distribution is the same for all factories
Likelihood of miss-association is based on observer Probability Distribution and on P_{FA} (the probability of “false alarm” i.e. vehicle not destined for any observed factory)
Can estimate p(x^{v}) from data:

$$p ( {}_{i}^{ } {z}_{ }^{f} , {}_{j}^{ }{z}{}_{ }^{r} \vert a ) = p ( {}_{i}^{ }{z}{}_{ v}^{f} , {}_{j}^{ }{z}{}_{ v}^{r} \vert a ) \cdot p ( {}_{i}^{ }{z}{}_{ t}^{f} , {}_{j}^{ }{z}{}_{ t}^{r} \vert a ) \\ p ( {}_{i}^{ }{z}{}_{ v}^{f} , {}_{j}^{ }{z}{}_{ v}^{r} \vert a ) = \frac{{\sum }_{{x}^{v}}^{ } p ( {}_{i}^{ }{z}{}_{ v}^{f} \vert {x}^{v} ) p ( {}_{j}^{ }{z}{}_{ v}^{r} \vert {x}^{v} ) p ( {x}^{v} )}{p ( {}_{i}^{}{z}{}_{v}^{f} ) p ( {}_{j}^{}{z}{}_{v}^{r} )} \\ \begin{matrix}p ( {}_{i}^{ }{z}{}_{ v}^{f} , {}_{j}^{ }{z}{}_{ v}^{r} \vert a ) = \frac{\int \int p ( {}_{i}^{ }{z}{}_{ t}^{f} \vert {x}_{f}^{t} ) p ( {}_{j}^{ }{z}{}_{ v}^{r} \vert {x}_{r}^{t} ) p ( {x}_{f}^{t} , {x}_{{r}^{t}} ) d {x}_{f}^{t} d {x}_{r}^{t}}{\overline{v} {p}^{0}} \\ = \frac{gampdf ( {}_{i}^{ }{z}{}_{ t}^{f} - {}_{j}^{ }{z}{}_{ t}^{r} ; k , θ )}{\overline{v} {p}^{0}}\end{matrix}$$

v̅=number of events≈min (N^{r},N^{f})ₚ⁰=1/Δt

p(ᵢz^{f}, z̅^{r}1a)=1−P_{D}^{r}(1−P_{FA})

p( z̅^{f},ⱼz^{r}1a)=1−P_{D}^{f}

P_{FA}=Probability of “false alarm” i.e. vehicle not destined for any observed factory

Given a set of road observation-to-factory associations ‘a’, the product production for each factory/can be computed and the Production Hypothesis: x^{p}ᵢ can be given as:

xᵢ^{p}∈{(vᵢ¹,vᵢ², . . . , vᵢ⁵)·nᵢ^{k}∈%₀,Σnᵢ^{k}≦MAX}

where n¹ is equal to the number of components required to fully assemble a particular type of product.

A set of vehicle production hypothesis can be formulated, and for each hypothesis computing the required component parts. The Required Components yᵢ^{p} can be given as:

yᵢ^{p}=L(xᵢ^{p}), yᵢ^{p}∈{(cᵢ¹,cᵢ², . . . , cᵢ¹⁰)·cᵢ^{k}∈%₀}

where c¹ is equal to the number of components of type 1.

N=Σc^{k}

The likelihood of the hypothesis can be computed by comparing the required component parts to the observed component parts (under association a):

p(Zᵢ^{p}|xᵢ^{p},a)=p(Zᵢ^{p}|yᵢ^{p},a)

The Road observations associated with the factory Zᵢ^{p}|a can be given as:

Zᵢ^{p}|a⊂Z^{p}#(Zᵢ^{p}|a)=M

For each factory, sum over associations the likelihoods for each production hypothesis, weighed by the association likelihood:

$$p ( {x}_{i}^{p} \vert {Z}_{i}^{p} , {Z}^{r} , {Z}^{f} ) ∝ p ( {x}^{p} ) \\ {\sum }_{a}^{ } P ( {Z}_{i}^{p} \vert {x}_{i}^{p} , a ) p ( a \vert {Z}^{r} , {Z}^{f} )$$

Bayes' rule is used to determine posterior over all the data and prior over hypothesis (flat prior used):

$$p ( {v}_{i}^{j} = k \vert \cdot ) = {\sum }_{{x}^{p}}^{ } p ( {v}_{i}^{j} = k \vert {x}_{i}^{p} ) p ( {x}^{p} \vert \cdot ) \\ p ( {v}_{i}^{j} = k \vert {x}_{i}^{p} ) = \{ \begin{matrix}1 & if {v}_{i}^{j} ( {x}_{i}^{p} ) = k \\ 0 & otherwise\end{matrix}$$

The probability of the number of each product (e.g. HGV) type is computed: p(vᵢ¹=k) is probability that k products/HGVs are produced at factory i

The expectation of each product/vehicle in production is computed:

$$E [ {v}_{i}^{j} \vert \cdot ] = {\sum }_{k = 0}^{MAX} k \cdot p ( {v}_{i}^{j} = k \vert \cdot )$$

The space of the associations can be massive:
Number of associations=n!
n=N^{r}+N^{f}

The top m associations can be found in O(mn³) time using Murty's algorithm, which minimises the sum of negative log likelihoods.

Problems can arise if the hypothesis space is very flat:
m^{th} most likely association almost as likely as the first
Most of the probability mass is in the m→n! associations
Cannot normalise the likelihoods to give meaningful probabilities
m most likely associations may be quite impoverished
Top m associations given road+factory may not be top m given part information

Calculation of p(Zᵢ^{p}|yᵢ^{p},a) can involve the following steps:
If there are more associated observations than required parts likelihood is zero, p(Z^{p}|x^{p},a)=0, else compute all M sized subset of the required parts (uⱼ):
For each subset compute all permutations of the subset (wₖ):

$$Number of subsets = \frac{N !}{{M}_{R} ! ( N - {M}_{R} ) !}$$

Number of permutations=M_{R}!

$$Complexity = \frac{N !}{( N - {M}_{R} ) !}$$

Match the permuted subset to the observations and compute the product of observation likelihoods
Sum the likelihoods for each permutation, and
Multiply sum by the likelihood of making M_{F} observations from N required components:

$$p ( {Z}_{i}^{p} \vert {y}_{i}^{p} , a ) = ( \begin{matrix}N \\ {M}_{F}\end{matrix} ) \cdot {( {P}_{D}^{f} )}^{{M}_{F}} \cdot {( 1 - {P}_{D}^{f} )}^{N - {M}_{F}} . \\ {\sum }_{k = 1}^{{M}_{R} !} {\sum }_{j = 1}^{N ! / ( {M}_{R} ! ( {M}_{R} - N ) ! )} p ( {Z}_{i}^{p} \vert {w}_{k} ) p ( {w}_{k} \vert {u}_{j} ) p ( {u}_{j} \vert {y}_{i}^{p} , a )$$

Using a test data set and given the ground truth number of vehicles/products produced at each factory and estimates, it is possible to calculate an error norm:

$$\frac{{\sum }_{i = 1}^{10} {\sum }_{j = 1}^{5} \vert [ \begin{matrix}{v}_{1}^{1} & … & {v}_{1}^{5} \\ ⋮ & ⋱ & ⋮ \\ {v}_{10}^{1} & … & {v}_{10}^{5}\end{matrix} ] - [ \begin{matrix}E [ {v}_{1}^{1} ] & … & E [ {v}_{1}^{5} ] \\ ⋮ & ⋱ & ⋮ \\ E [ {v}_{10}^{1} ] & … & E [ {v}_{10}^{5} ]\end{matrix} ] \vert}{{\sum }_{i = 1}^{10} {\sum }_{j = 1}^{5} \vert [ \begin{matrix}{v}_{1}^{1} & … & {v}_{1}^{5} \\ ⋮ & ⋱ & ⋮ \\ {v}_{10}^{1} & … & {v}_{10}^{5}\end{matrix} ] - [ \begin{matrix}0.2 & … & 0.2 \\ ⋮ & ⋱ & ⋮ \\ 0.2 & … & 0.2\end{matrix} ] {\sum }_{i = 1}^{10} {\sum }_{j = 1}^{5} {v}_{i}^{j} \vert}$$

where the v^{l}ₗ terms in the expression represent the true production at each factory; the E[v^{l}ₗ] . . . term represents the estimates; the 0.2 . . . term represents the uniform prior, and the summated v^{l}ₗ term represents the total number of products produced.

If the estimate is perfect then the error=0.

If the estimate is uniform prior then the error=1.

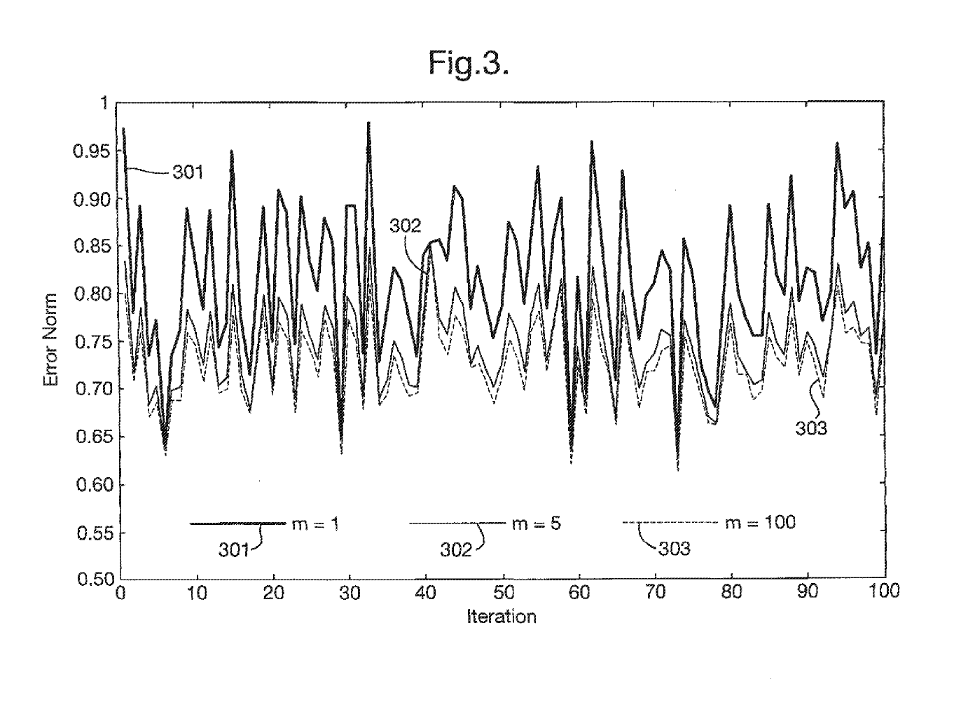

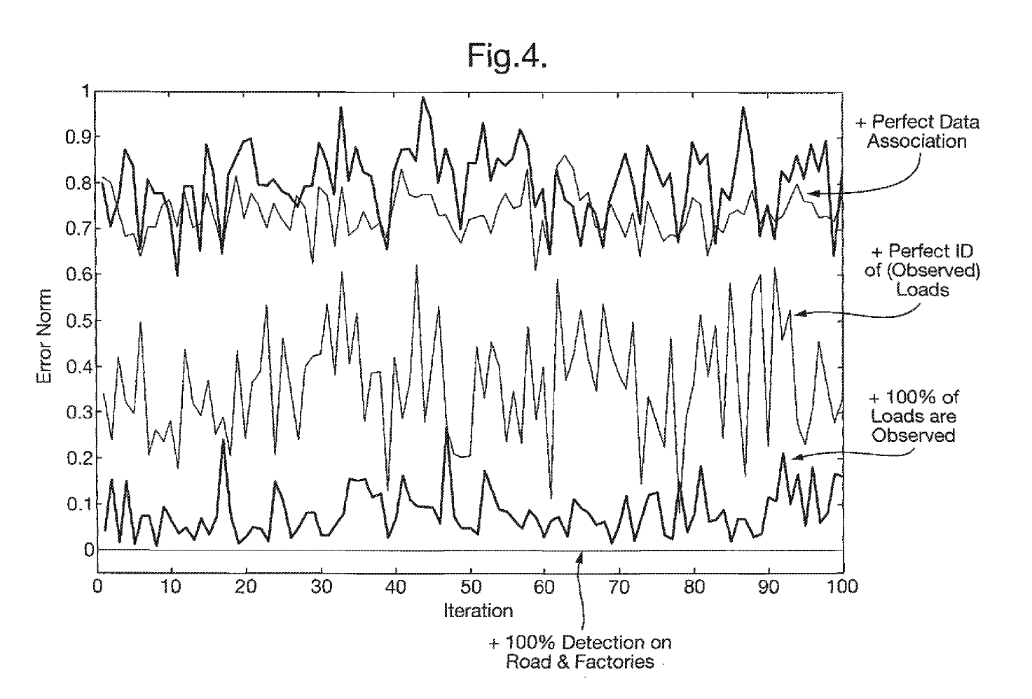

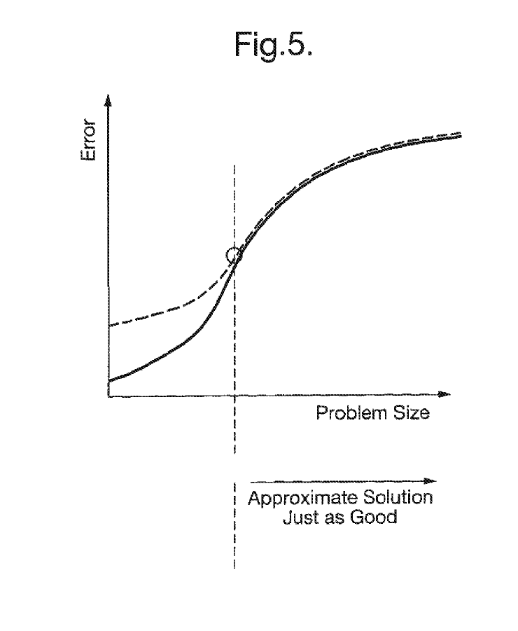

For the purpose of analysis, multiple (e.g. 100) iterations of data were generated, with a known number of deliveries and HIGH/LOW/MEDIUM reports, etc. Each iteration created a different random population of: CCTV observations; delivery vehicle types; delivery delay times, and component delivery order. The value of the error norm and how it varies across iterations were investigated, as well as the effect of the varying the Murty ‘m’ value (e.g. m=1, m=5, m=100). The results of this are shown in the graph of FIG. 3. The results of tests involving incremental improvement of data quality (i.e. perfect data association; perfect id of 50% of loads; perfect id of 100% of loads, and 100% detection on road/at factories (up from 95%)) is shown in the graph of FIG. 4. From tests such as these, the present inventors concluded that an implementation involving Murty's algorithm makes good use of available information, but there is no analytic mechanism to quantify the accuracy of the result. It is also essential to perform empirical evaluation. A significant disadvantage is the poor computational scaling. For an alternative inventive implementation that uses parameterised distributions fitted to data and replaces Murty's algorithm with Soft-assign it was found that as the problem size grows the benefit of combinatorics decreases (as illustrated in FIG. 5).

In an N×N score matrix there are N! possible assignments. The Murty approach involves generating m top assignments (m<<N), but such a forced m-cut may bias subsequent results. Theoretically, a distribution of all possible assignments consistent with the data is desirable—a ‘soft’ assignment. The present inventors have identified several approaches that can produce a suitable assignment. These approaches have been applied to the same field in the past and are not even widely-known by persons skilled in the fusion area:
Soft-assign algorithm (Steven Gold, Anand Rangarajan, Chien-Ping Lu, Suguna Pappu and Eric Mjolsness, New Algorithms for 2D and 3D Point Matching: Pose Estimation and Correspondence, Pattern Recognition, 31(8):1019-1031, 1998.)
Information-form data association (B. Schumitsch, S. Thrun, G.

Bradski, and K. Olukotun. The information-form data association filter. In NIPS. 2006)
Markov-Chain Monte-Carlo EM (Monte Carlo EM for Data-Association and its Applications in Computer Vision, Frank Dellaert doctoral dissertation, tech. report CMU-CS-01-153, Computer Science Department, Carnegie Mellon University, September, 2001)
Fourier-theoretic inference on permutations (J. Huang, C.

Guestrin, and L. Guibas. Fourier theoretic probabilistic inference over permutations. Journal of Machine Learning Research, 10, 2009)

These approaches effectively solve a maximisation problem:

$$E ( m ) = {\sum }_{j = 1}^{J} {\sum }_{k = 1}^{K} {m}_{jk} {Q}_{jk}$$

They may be based on a deterministic annealing method and enforce a doubly stochastic matrix with constraints on m (continuous analogue of a permutation matrix).

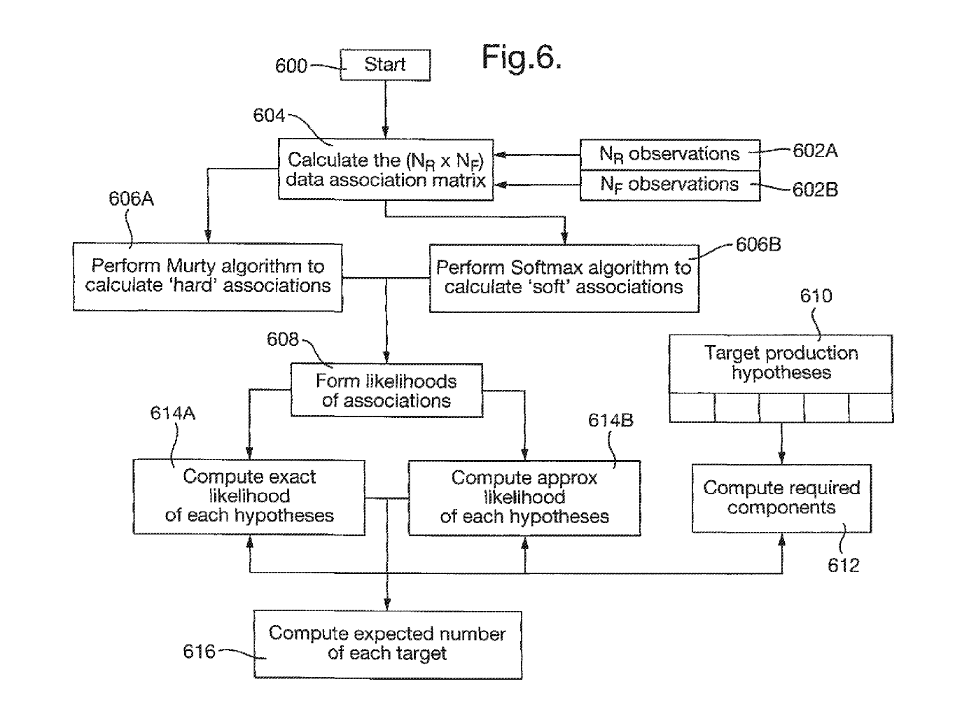

FIG. 6 is a flowchart illustrating an example embodiment of steps 202 to 210 of FIG. 2. The example process starts at step 600 and observations N_{R} and N_{F} are received at 602A, 602B, which can correspond to observations made by the road sensors 106 and factory CCTVs 108, respectively. A data association matrix using these data values is generated at step 604.

Step 606A represents the use of an accurate inference procedure, such as one based on the Murty algorithm, to calculate hard data associations within the data matrix. Step 606B represents the use of an inference procedure that is less computationally expensive and provides less accurate results that are considered acceptable approximations, such as the use of the Softassign algorithm discussed above. It will be appreciated that the embodiment illustrated can be used for experimental purposes and in other embodiments, only one of the steps 606A, 606B may be implemented; for instance, in a practical implementation, only the less computationally-expensive process 606B may be executed.

At step 608 likelihoods of associations are formed as outlined above. Target production hypotheses 610 are formed and at step 612 the number of components that would be required to satisfy each of the hypotheses is computed. At step 614A the exact likelihood of each target production hypothesis being true is computed. At step 614B an approximate likelihood of each target production hypothesis being true is computed. Again, it will be appreciated that the embodiment illustrated can be used for experimental purposes and in other embodiments, only one of the steps 614A, 614B may be implemented; for instance, in a practical implementation, only the less computationally-expensive process 614B may be executed. At step 616, the expected number of each target, e.g. the number of vehicles of each type, according to one or more of the most likely hypotheses as computed in the previous step, is computed.

Computing the likelihood of the production hypothesis as in step 614A is computationally demanding. An exact and fast solution is available if there is no observation uncertainty. The present inventors has discovered that production hypothesis probability can be computed using hyper-geometric distribution HGM. Hyper-geometric is analogous to multi-nominal distribution, but without replacement (see website: en.wikipedia.org/wiki/Hypergeometric_distribution):

$$p ( {Z}_{i}^{p} \vert {y}_{i}^{p} , a ) = ( \begin{matrix}N \\ {M}_{F}\end{matrix} ) \cdot {( {P}_{D}^{f} )}^{{M}_{F}} \cdot {( 1 - {P}_{D}^{f} )}^{N - {M}_{F}} . \\ {\sum }_{k = 1}^{{M}_{R} !} {\sum }_{j = 1}^{N ! / ( {M}_{R} ! ( {M}_{R} - N ) ! )} p ( {Z}_{i}^{p} \vert {w}_{k} ) p ( {w}_{k} \vert {u}_{j} ) p ( {u}_{j} \vert {y}_{i}^{p} , a )$$

The p(uⱼ|y^{p}ᵢ, a) term corresponds to:

$${p}_{H} ( {y}_{1} , … , {y}_{n} \vert {x}_{1} , … , {x}_{n} ) = \frac{Π ( \begin{matrix}{x}_{i} \\ {y}_{i}\end{matrix} )}{( \begin{matrix}\sum {x}_{i} \\ \sum {y}_{i}\end{matrix} )}$$

The number of mixture components grows exponentially and the component weight is also the sum of a potentially large number of terms:

$${}^{:} p ( {Z}_{i}^{p} \vert {y}_{i}^{p} , a ) \approx ( \begin{matrix}N \\ {M}_{F}\end{matrix} ) \cdot {( {P}_{D}^{f} )}^{{M}_{F}} \cdot {( 1 - {P}_{D}^{f} )}^{N - {M}_{F}} . \\ {p}_{H} ( E [ {c}^{1} \vert {Z}_{i}^{p} , a ] , … , E [ {c}^{10} \vert {Z}_{i}^{p} , a ] \vert {c}_{i}^{1} , … , {c}_{i}^{10} )$$

The expected number of each component given the observations may be:

$$E [ {c}^{k} \vert {Z}_{i}^{p} , a ] = {\sum }_{{z}_{j}^{′} ∈ {Z}_{i}^{p} \vert a}^{ } p ( {z}_{j}^{r} \vert {c}^{k} )$$

Alternatives to the above approach include:
Only computing the most significant components
Finding the best single hyper-geometric distribution
Guessing at the parameters of a single (not best) hyper-geometric distribution

It is also possible to use continuous generalisation of binomial co-efficient to implement hyper-geometric distribution:

$$( \begin{matrix}x \\ y\end{matrix} ) = \frac{Γ ( x + 1 )}{Γ ( y + 1 ) Γ ( x - y + 1 )}$$

There remains a need to integrate over association hypothesis if the association space is still very flat. The soft-assign algorithm can be used to compute expect association probabilities:

$$p ( {Z}_{i}^{p} \vert {y}_{i}^{p} , {Z}^{r} , {Z}^{f} ) \approx ( \begin{matrix}N \\ {M}_{F}\end{matrix} ) \cdot {( {P}_{D}^{f} )}^{{M}_{F}} \cdot {( 1 - {P}_{D}^{f} )}^{N - {M}_{F}} . \\ {p}_{H} ( E [ {c}^{1} \vert {Z}_{i}^{p} ] , … , E [ {c}^{10} \vert {Z}_{i}^{p} ] \vert {c}_{i}^{1} , … , {c}_{i}^{10} )$$

The number of components arriving at each factory given both observation and association uncertainty can be computed:

$$E [ {c}^{k} \vert {Z}_{i}^{p} ] = {\sum }_{{z}_{j}^{r} ∈ {Z}^{p}}^{ } p ( {z}_{j}^{p} ∈ {Z}_{i}^{p} ) p ( {}_{j}^{ }{z}{}_{ }^{r} \vert {c}^{k} )$$

Approximate hypothesis likelihood tunction will be exact when there is no observation or association uncertainty:

$$p ( {z}_{j}^{p} ∈ {Z}_{i}^{p} ) = {\sum }_{{}_{i}^{}{z}{}_{k}^{f} ∈ {Z}_{i}^{f}} p ( ( {}_{i}^{}{z}{}_{k}^{f} , {z}_{j}^{r} ) ∈ a )$$

The term following the summation symbol in the above expression can be derived from Soft-assign.

1. A method of generating an indication of a probability of a hypothesis being correct based on a set of observations, the method comprising:
obtaining data representing a first set of observations;
obtaining data representing a second set of observations;
obtaining data representing a set of hypotheses at least partially derivable from the first and the second sot sets of observations;
generating a plurality of data associations between at least some data in the first set and some data in the second set;
generating an indication of a probability of at least some of the generated data associations being correct; and
generating, based on the data representing the set of hypotheses and the indication of the probability of at least some of the generated data associations being correct, an indication of a probability of at least one of the hypotheses represented by the data being correct.

2. A method according to claim 1, wherein generating the plurality of data associations between at least some data in the first set and data in the second set comprises:
generating a data association matrix.

3. A method according to claim 2, wherein an ij^{th} element of the data association matrix comprises:
a value representing a joint probability that data relating to an i^{th} observation from the first set is associated with data relating to a j^{th} observation from the second set.

4. A method according to claim 1, wherein generating a plurality of data associations between at least some data in the first set and data in the second set involves a Soft-assign technique.

5. A method according to claim 1, wherein generating a plurality of data associations between at least some data in the first set and data in the second set involves an Information-form data association technique.

6. A method according to claim 1, wherein generating a plurality of data associations between at least some data in the first set and data in the second set involves a Markov-Chain Monte-Carlo EM technique.

7. A method according to claim 1, wherein generating a plurality of data associations between at least some data in the first set and data in the second set involves a Fourier-theoretic inference on permutations technique.

8. A method according to claim 1, wherein the set of hypotheses comprises:
a hypothesis that a set of products is being assembled at a set of locations, and the first and second observations sets comprise observations relating to components potentially used in an assembly of the products.

9. A method according to claim 8, wherein the observations comprise:
an observation of a component being transported to one of the locations.

10. A method according to claim 8, wherein the generating, based on the data representing the set of hypotheses and the indication of the probability of at least some of the generated data associations being correct, comprises:
computing combinations of particular components being used to assemble a particular product at a particular location.

11. A method according to claim 10, comprising:
detecting a threat using an output relating to a computed correctness.

12. A method according to claim 1, wherein the generating, based on the data representing the set of hypotheses and the indication of the probability of at least some of the generated data associations being correct, comprises:
executing a hyper-geometric distribution (HGM) technique.

13. A method according to claim 12, wherein the (HGM) technique comprises:
finding a best hyper-geometric distribution.

14. A computer program product formed as a non-transitory computer readable medium, having thereon computer program code, which will cause a computer to execute a method according to claim 1.

15. A system configured to generate an indication of a probability of a hypothesis being correct based on a set of observations, the system comprising:
a device configured to obtain data representing a first set of observations;
a device configured to obtain data representing a second set of observations;
a device configured to obtain data representing a set of hypotheses at least partially derivable from the first and the second sets of observations;
a device configured to generate a plurality of data associations between at least some data in the first set and some data in the second set;
a device configured to generate an indication of a probability of at least some of the generated data associations being correct; and
a device configured to use generate, based on the data representing the set of hypotheses and the indication of the probability of at least some of the generated data associations being correct, an indication of a probability of at least one of the hypotheses represented by the data being correct.
